(19) United States
(12) Patent Application Publication
(10) Pub. No.: US 2019/0323443 A1
(43) Pub. Date: Oct. 24, 2019

(54) A METHOD AND A SYSTEM FOR CONTROLLING A GAS ENGINE

(71) Applicant: Scania CV AB, Södertälje (SE)

(72) Inventor: Svante LÖTHGREN, Hägersten (SE)

(73) Assignee: Scania CV AB, Södertälje (SE)

(21) Appl. No.: 16/309,966

(22) PCT Filed: May 19, 2017
(86) PCT No.: PCT/SE2017/050532

§ 371 Date: Dec. 14, 2018

(30) Foreign Application Priority Data
Jun. 21, 2016 (SE) 1650873-1

(51) Int. Cl. F02D 41/00; F02D 19/02; F02M 21/02; F02P 5/15

(52) U.S. Cl. CPC F02D 41/0027; F02D 19/029; F02D 19/027; F02D 19/024; F02D 2200/0611; F02M 21/0221; F02M 21/0239; F02M 21/0287; F02P 5/15; F02M 21/0215

(57) ABSTRACT

The present disclosure relation relates to a system and method for controlling a gas engine, wherein the gas engine is supplied with a fuel gas which consists of different molecules and which is stored in at least a gaseous phase and a liquid phase in a gas storage device. The system comprises means for determining from which of its liquid or gaseous phase the fuel gas is taken out of the gas storage device. The system further comprises means for adapting the control of the gas engine in case it is determined that the phase from which the fuel gas is taken out of the gas storage device has changed.

### CROSS-REFERENCE TO RELATED APPLICATION(S)

This application is a national stage application (filed under 35 § U.S.C. 371) of PCT/SE2017/050532, filed May 19, 2017 of the same title, which, in turn, claims priority to Swedish Application No. 1650873-1 filed Jun. 21, 2016; the contents of each of which are hereby incorporated by reference.

### FIELD OF THE INVENTION

The present disclosure relates to a method and a system for controlling a gas engine. The present disclosure also relates to a vehicle, a computer program, and a computer program product.

### BACKGROUND OF THE INVENTION

Gas engines, especially for vehicles, are becoming more and more popular. However, when refuelling such vehicles at a gas station, the gas composition of a fuel gas can vary considerably between different gas stations. Since the composition of the fuel gas can differ, it is advisable to adapt the engine control to a given gas composition. This is done for optimizing the amount of energy which can be used for propelling the vehicle and/or for optimizing the composition of the exhaust of the gas engine in such a way that its impact to the environment is minimized and legal requirements are fulfilled.

### SUMMARY OF THE INVENTION

Adaptions of the engine control in prior art are usually only performed upon refuelling. They thus might miss changes in the composition of the fuel gas which is supplied to the gas engine from the gas storage device in case these changes occur during driving. There exist methods which periodically adapt the engine control. However, it might happen that a change in composition occurs directly after a periodical update. This might result in that the engine is controlled in a non-optimal manner for quite some time. On the other hand, constantly performing an adaptation is not a solution either, since an adaption of the engine control takes some time and usually prevents the performing of other methods which also might be needed for optimizing the gas engine.

It is thus an object of the present invention to perform an adaption of the engine control only in case such an adaption is needed.

The present disclosure is intended for fuel gas which is stored in a liquid and a gaseous phase in a gas storage device. In such a gas storage device the fuel gas will vaporise and condensate. However, in case the gas consists of different kinds of molecules, not all kind of molecules will evaporate/condensate at the same rate. Instead, lighter molecules will evaporate at a faster rate than heavier molecules. Thus, the composition of the fuel gas will differ between its gaseous phase and its liquid phase. In other words, although one kind of gas will be fuelled to the vehicle at a gas station, this gas will split up into two different compositions in the gas storage device. This is an important insight for understanding why steps in the present disclosure are performed.

Another object of the present invention is to present an advantageous control of a gas engine. Yet another object of the present invention is to present an alternative control of a gas engine.

At least some of the objects are achieved by a method for controlling a gas engine, wherein the gas engine is supplied with a fuel gas which consists of different kinds of molecules and which is stored in at least a gaseous phase and a liquid phase in a gas storage device. The method comprises determining from which of its liquid or gaseous phase the fuel gas is taken out of the gas storage device. The method further comprises adapting the control of the gas engine in case it is determined that the phase from which the fuel gas is taken out of the gas storage device has changed.

Adapting the control of the gas engine based on a detected change of the phase of the fuel gas taken out of the gas storage device allows performing the adaption only when needed, namely when a different gas composition will be supplied to the gas engine. Since the liquid phase and the gaseous phase will differ in its composition, the gas engine should be adapted to the new composition supplied to the gas engine. This allows minimizing unwanted exhaustions and/or optimizing the amount of energy which can be taken out of the gas and can be converted to rotational energy of the gas engine.

In one example, the method further comprises determining a pressure value of the fuel gas in the gas storage device. Said determination from which of its liquid or gaseous phase the fuel gas is taken out of the gas storage device is based on said determined pressure value of the fuel gas in the gas storage device. This is especially useful for engine systems where valves are not connected to a control unit. It thus allows determining a state of a valve without a need to control the valve. This might be advantageous when performing the method on existing vehicles without a need for hardware arrangements.

In one example the method further comprises determining a time derivative of pressure values of the fuel gas in the gas storage device. Said determination from which of its liquid or gaseous phase the fuel gas is taken out of the gas storage device is based on said determined time derivative of the pressure values of the fuel gas in the gas storage device. This is especially useful when no information regarding parameters of a valve arrangement is present. In case parameters of a valve arrangement are available, such an example of the method further allows monitoring the proper functioning of the valve arrangement.

In one example, said determining from which of its liquid or gaseous phase the fuel gas is taken out of the gas storage device is based on a model of the fuel gas and/or the gas storage device. This dispenses with measurement arrangements, thus minimizing needed equipment for performing the method.

In one example said determining from which of its liquid or gaseous phase the fuel gas is taken out of the gas storage device is based on a determined state of a valve arrangement at an output of the gas storage device. This allows for an easy way of determining the phase and might dispense with some hardware requirements.

In one example, adapting the control of the gas engine comprises adapting the amount of fuel gas which is injected in the gas engine per injection process. This is an important parameter when optimizing the functioning of the gas engine.

In one example, adapting the control of the gas engine comprises adapting the point in time of igniting the fuel gas in the gas engine. This is an important parameter when optimizing the functioning of the gas engine.

In one example, the fuel gas which is stored in at least a gaseous phase and a liquid phase in the gas storage device is liquefied natural gas, LNG. LNG is an important fuel gas and the method is especially suitable for that gas.

At least some of the objects are also achieved by a system for controlling a gas engine, wherein the gas engine is supplied with a fuel gas which consists of different molecules and which is stored in at least a gaseous phase and a liquid phase in a gas storage device. The system comprises means for determining from which of its liquid or gaseous phase the fuel gas is taken out of the gas storage device. The system further comprises means for adapting the control of the gas engine in case it is determined that the phase from which the fuel gas is taken out of the gas storage device has changed.

In one embodiment the system further comprises means for determining a pressure value of the fuel gas in the gas storage device. Said means for determining from which of its liquid or gaseous phase the fuel gas is taken out of the gas storage device is adapted to base said determining on said determined pressure value of the fuel gas in the gas storage device.

In one embodiment the system further comprises means for determining a time derivative of pressure values of the fuel gas in the gas storage device. Said means for determination from which of its liquid or gaseous phase the fuel gas is taken out of the gas storage device is adapted to base said determining on said determined time derivative of the pressure values of the fuel gas in the gas storage device.

In one embodiment said means for determining from which of its liquid or gaseous phase the fuel gas is taken out of the gas storage device are adapted to base said determining on a model of the fuel gas and/or the gas storage device.

In one embodiment said means for determining from which of its liquid or gaseous phase the fuel gas is taken out of the gas storage device are adapted to base said determining on a determined state of a valve arrangement at an output of the gas storage device.

In one embodiment the means for adapting the control of the gas engine comprises means for adapting the amount of fuel gas which is injected in the gas engine per injection process.

In one example the means for adapting the control of the gas engine comprises means for adapting the point in time of igniting the fuel gas in the gas engine.

In one example the fuel gas which is stored in at least a gaseous phase and a liquid phase in the gas storage device is liquefied natural gas.

At least some of the objects are also achieved by a vehicle comprising the system for controlling a gas engine.

At least some of the objects are also achieved by a computer program for controlling a gas engine, wherein the gas engine is supplied with a fuel gas which is stored in at least a liquid and a gaseous phase in a gas storage device and which consists of different molecules, wherein said computer program comprises program code for causing an electronic control unit or a computer connected to the electronic control unit to perform the method according to the present disclosure.

At least some of the objects are also achieved by a computer program product containing a program code stored on a computer-readable medium for performing the method according to the present disclosure, when said computer program is run on an electronic control unit or a computer connected to the electronic control unit.

The system, the vehicle, the computer program and the computer program product have corresponding advantages as have been described in connection with the corresponding examples of the method according to this disclosure.

Further advantages of the present invention are described in the following detailed description and/or will arise to a person skilled in the art when performing the invention.

### BRIEF DESCRIPTION OF THE DRAWINGS

For a more detailed understanding of the present invention and its objects and advantages, reference is made to the following detailed description which should be read together with the accompanying drawings. Same reference numbers refer to same components in the different figures. In the following,

FIG. 1 shows, in a schematic way, a vehicle according to one embodiment of the present invention;

FIG. 2 shows, in a schematic way, an engine system comprising a system according to one embodiment of the present invention;

FIG. 3 shows, in a schematic way, an example of a pressure value over time as it could occur when performing the present disclosure;

FIG. 4 shows, in a schematic way, a flow chart over an example of a method according to the present invention; and

FIG. 5 shows, in a schematic way, a device which can be used in connection with the present invention.

### DETAILED DESCRIPTION OF THE INVENTION

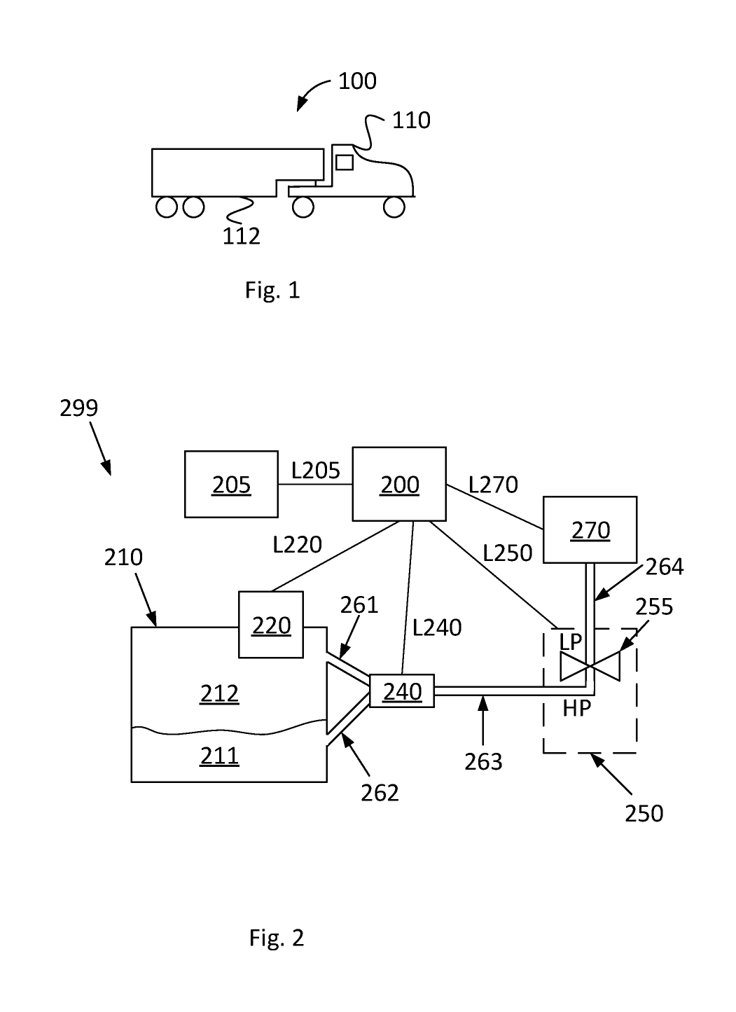

FIG. 1 shows a side view of a vehicle 100. In the shown example, the vehicle comprises a tractor unit 110 and a trailer unit 112. The vehicle 100 can be a heavy vehicle such as a truck. In one example, no trailer unit is connected to the vehicle 100. The vehicle 100 can comprise a gas engine. The vehicle can comprise a system for controlling the gas engine. The vehicle 100 can comprise an engine system 299, see FIG. 2a. The engine system 299 can be arranged in the tractor unit 110.

In one example, the vehicle 100 is a bus. The vehicle 100 can be any kind of vehicle comprising a gas engine. Other examples of vehicles comprising a gas engine are boats, passenger cars, construction vehicles, and locomotives. The present invention can also be used in connection with any other platform than vehicles, as long as this platform comprises a gas engine. One example is a power plant with a gas engine.

The innovative method and the innovative system according to one aspect of the invention are also well suited to, for example, systems which comprise industrial engines and/or engine-powered industrial robots.

In the following, the system for controlling a gas engine will be described as it can be embodied when using it in a vehicle. As a consequence, not all components in the description are necessary. Instead, most of the components are optional. They are, however, added in the description for showing a preferred embodiment of the present disclosure.

The term “link” refers herein to a communication link which may be a physical connection such as an opto-electronic communication line, or a non-physical connection such as a wireless connection, e.g. a radio link or microwave link.

The term “passage” refers herein to a passage suitable for transporting gas. The passage can, for example, be a pipe, a hose, a tube, a channel, or the like. The passage can be rigid or flexible.

In the following the term “gas” and “fuel gas” are used interchangeably. No different meaning is intended.

In the following, molecules only differing by different isotopes are not considered to be “different kind of molecules”.

FIG. 2 shows schematically an embodiment of an engine system 299 comprising a gas storage device 210, a gas engine 270, and comprising a system for controlling the gas engine 270, wherein the gas engine 270 is supplied with a fuel gas which is stored in at least a liquid and a gaseous phase in the gas storage device 210 according to the present invention. It should be emphasized that not all the components of the engine system 299 are necessary in a system for controlling the gas engine, wherein the gas engine is supplied with a fuel gas which is stored in at least a liquid and a gaseous phase in the gas storage device. The necessary components are solely those in the accompanying claims. However, since the system for controlling the gas engine necessarily will interact with the gas storage device and the gas engine, the engine system 299 comprises the gas storage device, the gas engine, the system for controlling the gas engine, as well as other components.

The gas storage device 210 can be a gas tank. The gas storage device 210 can comprise several gas tanks. The gas storage device 210 is arranged to store a fuel gas in at least a liquid phase 211 and a gaseous phase 212. In one example, the fuel gas is only stored in the liquid phase 211 and the gaseous phase 212.

The fuel gas which is stored in the gas storage device 210 is in one example liquefied natural gas, LNG. LNG is a common two-phase gas which is used for propelling vehicles. LNG comprises different kind of molecules. Examples of molecules which can be comprised in LNG are methane, ethane, propane, butane, ethane, and the like. LNG is usually stored well below −100 degree Celsius in the gas storage device. In the following, the disclosure will be described in connection to LNG. It should, however, be noted that any other fuel gas which consists of different molecules and which can be stored in at least a liquid phase and a gaseous phase in the gas storage device 210 would be suitable as well.

The engine system 299 comprises at least one passage 261, 262, 263, 264. Said at least one passage 261, 262, 263, 264 is arranged for transporting the gas from the storage device 210 to the gas engine 270. Said at least one passage 261, 262, 263, 264 can comprise a first passage section 261. Said first passage section 261 is arranged to transport gas which is extracted from a first phase from the gas storage device 210, such as from the gaseous phase 212. Said at least one passage 261, 262, 263, 264 can comprise a second passage section 262. Said second passage section 262 is arranged to transport gas which is extracted from a second phase from the gas storage device 210, such as from the liquid phase 211.

Said engine system 299 comprises a valve arrangement 240. Said valve arrangement 240 can be arranged to allow the passing of the gas from a first phase in the gas storage device 210 through the valve arrangement 240. Said valve arrangement 240 can be arranged to prevent the passing of the gas from a first phase in the gas storage device 210 through the valve arrangement 240. Said valve arrangement 240 can be arranged to allow the passing of the gas from a second phase in the gas storage device 210 through the valve arrangement 240. Said valve arrangement 240 can be arranged to prevent the passing of the gas from a second phase in the gas storage device 210 through the valve arrangement 240. In a preferred embodiment, the valve arrangement 240 is arranged to switch between a first state, where it is arranged to allow the passing of the gas from a first phase in the gas storage device 210 through the valve arrangement 240 and to prevent the passing of the gas from a second phase in the gas storage device 210 through the valve arrangement 240, and a second state, where it is arranged to prevent the passing of the gas from a first phase in the gas storage device 210 through the valve arrangement 240 and to allow the passing of the gas from a second phase in the gas storage device 210 through the valve arrangement 240. The valve arrangement 240 can comprise a so-called economiser. In one example, the first phase is the gaseous phase and the second phase is the liquid phase.

The first passage 261 section can be arranged to transport the gas to the valve arrangement 240. The second passage 262 section can be arranged to transport the gas to the valve arrangement 240. The valve arrangement 240 comprises preferably at least one valve. In one embodiment, the valve arrangement 240 comprises only one valve. The only one valve can be arranged to switch between a first state of only allowing gas from the first passage section 261 to pass and between a second state of only allowing gas from the second passage section 262 to pass.

In another embodiment, the valve arrangement comprises several valves. As an example, the valve arrangement could comprise different valves for opening and closing the passage in the first and in the second passage sections 261, 262, respectively.

The valve arrangement 240 can be arranged to switch between a first state and a second state depending on an input pressure. Said input pressure could be a pressure which is exposed to the valve arrangement 240 via the gas storage device 210. In one example, said input pressure is the pressure from the gaseous phase which is exposed to the valve arrangement 240 via said first passage section 261. The valve arrangement can be arranged to switch between said first and said second state upon a threshold value of said input pressure. In one example, said threshold is 10 bar. The valve arrangement is in one example arranged to perform the switching purely mechanically. It is thus not needed to electrically control the valve arrangement 240. However, in one embodiment the valve arrangement 240 is controlled electrically.

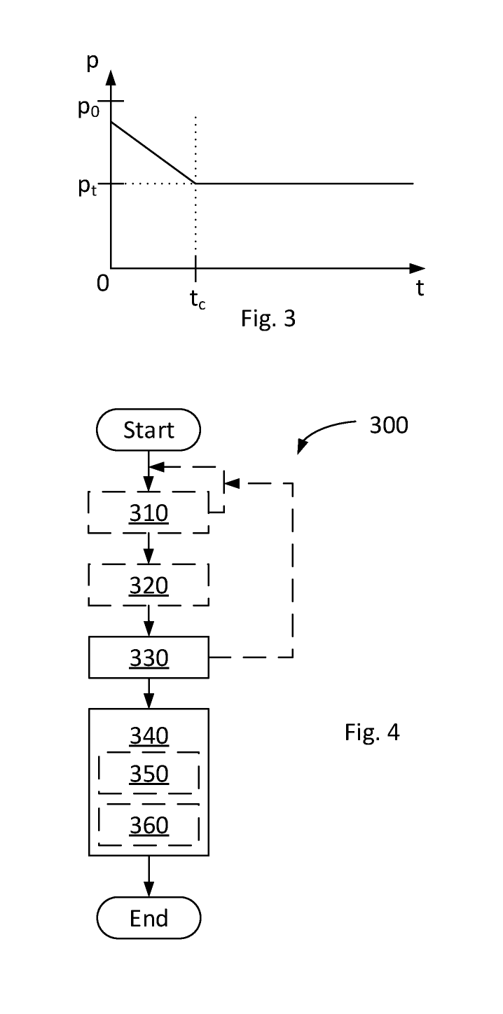

The engine system 299 comprises a gas regulator system 250. The gas regulator system comprises a gas regulator 255. The gas regulator system 250 is arranged downstream the gas storage device 210. The gas regulator system 250 is situated downstream the valve arrangement 240. Said at least one passage 261, 262, 263, 264 can comprise a third passage section 263. Said third passage section 263 can be arranged to transport gas from the valve arrangement 240 to the gas regulator system 250. The gas regulator 255 has a high pressure, HP, side The HP side is on the side exposed to the gas flow from the gas storage device 210. In one example, the pressure on the HP side is in the range between 0 and 16 bar. This will be more elaborated in relation to FIG. 3. The gas regulator 255 has a low pressure, LP, side. The LP side is on the side which is not exposed to the gas flow from the gas storage device 210. The gas regulator system 250 is arranged to transfer the pressure from the HP side to the LP side.

The engine system 299 comprises a gas engine 270. The gas engine 270 can be arranged to propel a vehicle. The gas engine 270 is in gas flow contact to the gas regulator system 250. The gas engine has a preferred input gas pressure. This preferred input gas pressure is supplied by the gas regulator system 250. In one example, the preferred input gas pressure is 8 bar, or approximately 8 bar. In that case, the gas regulator system 255 is arranged to transfer the gas pressure from the HP side so that it will achieve 8 bar at the LP side. Said at least one passage 261, 262, 263, 264 can comprise a fourth passage section 264. Said fourth passage section 264 can be arranged to transport gas from the gas regulator 255 to the gas engine 270. The gas engine 270 can be a gas engine with direct injection. In other words, the gas is directly injected into at least one combustion chamber of the gas engine 270 without first being mixed with air to an air/fuel-mixture.

Preferably, a common injection is used for the liquid and the gaseous phase. In other words, no separate injection systems are used for the liquid and the gaseous phase, respectively. In one example, the injection to the gas engine 270 is placed downstream the valve arrangement 240. In one example, the injection to the gas engine 270 is placed downstream the third and/or the fourth passage section 263, 264.

The engine system 299 comprises measurement means 220. In one example, said measurement means 220 comprises one or several pressure sensor. Said measurement means 220 is arranged to determine a pressure in the gas storage device 210. Said pressure can be a pressure of the fuel gas in its gaseous phase. Said pressure can be a pressure of the fuel gas in its liquid phase. Said measurement means 220 can be arranged to measure a pressure value of the fuel gas in the gas storage device. In one example, the fuel gas is thermodynamically saturated in the gas storage device 210. In the shown example, the measurement means 220 are arranged at least partly inside the gas storage device 210. In an alternative embodiment the measurement means could be arranged in the first passage section 261 and/or the second passage section 262, and/or the third passage section. Since these passage sections are connected to the gas storage device 210 the pressure inside the passage section either corresponds to the pressure in the gas storage device, or at least can be converted to a pressure in the gas storage device 210.

The engine system 299 can further comprise a heat exchange system (not shown in the figure). The heat exchange system can use cooling water from the gas engine to heat the gas in preferably any of the third passage section 263 or the fourth passage section 264. This assures that fuel gas extracted from the liquid phase 211 in the gas storage device 210 will be converted into its gaseous phase when reaching the gas engine 270 and/or the regulator system 250.

The engine system 299 comprises a first control unit 200.

Said first control unit 200 is arranged to control operation of said gas engine 270. Said first control unit 200 is arranged for communication with said gas engine 270 via a link L270. Said first control unit 200 is arranged to receive information from said gas engine 270.

Said first control unit 200 is arranged to control operation of said gas regulator system 250. Said first control unit 200 is arranged for communication with said gas regulator system 250 via a link L250. Said first control unit 200 is arranged to receive information from said gas regulator system 250.

Said first control unit 200 is arranged to control operation of said measurement means 220. Said first control unit 200 is arranged for communication with said measurement means 220 via a link L220. Said first control unit 200 is arranged to receive information from said measurement means 220. In case the engine system 299 comprises several pressure sensors, said first control unit 200 can be arranged for communication with each of these several pressure sensors. Said first control unit 200 can then be arranged to receive information from said several pressure sensors.

Said first control unit 200 and/or measurement means 220 is in one example arranged to determine a pressure value of the fuel gas in the gas storage device 210. Said determining of a pressure value can be continuously or intermittently. A determining of a pressure value does usually not interfere with any other functions of the engine system 299. Said first control unit 200 and/or said measurement means 220 is in one example arranged to determine a time derivative of pressure values of the fuel gas in the gas storage device.

In one embodiment, said first control unit 200 is arranged to control operation of said valve arrangement 240. Said first control unit 200 is arranged for communication with said valve arrangement 240 via a link L240. Said first control unit 200 is arranged to receive information from said valve arrangement 240. In one example, said first control unit 200 is arranged to control the valve arrangement 240 to switch from a first state to a second state, or vice versa.

Said first control unit 200 is arranged to determine from which of its liquid or gaseous phase the fuel gas is taken out of the gas storage device 210. In one example this is performed based on a determined pressure value of the fuel gas. As an example, the valve arrangement 240 could be arranged to switch between a first state and a second state depending on whether it is exposed to a pressure value above or below a threshold, as described above. This threshold can be denoted switch threshold. As a consequence, when determining the pressure value of the fuel gas, it can be concluded whether this value is above or below the switch threshold. From that, the state of the valve arrangement 240 can be determined. This is especially useful in case the valve arrangement 240 is not controlled by the first control unit 200.

In one example said first control unit 200 is arranged to determine from which of its liquid or gaseous phase the fuel gas is taken out of the gas storage device based on a time derivative of pressure values of the fuel gas in the gas storage device. As an example, the first control unit 200 can be arranged to store determined pressure values from the measurement means 220. Storing these pressure values for a pre-determined time period and knowing the time between the moment of time when these pressure values where determined allows determining a time derivative. How the phase can be determined in this case is described in more detail in relation to FIG. 3.

In one example said first control unit 200 is arranged to control the valve arrangement 240, especially to control the valve arrangement 240 so that it switches from a first state to a second state, or vice versa. In case the valve arrangement 240 is controlled by the first control unit 200, the first control unit 200 will automatically know from which of the liquid or the gaseous phase the fuel gas is taken out of the gas storage device 210.

Said first control unit 200 is arranged to adapt the control of the gas engine 270 in case it is determined that the phase from which the fuel gas is taken out of the gas storage device 210 has changed. In one example, said first control unit 200 is arranged to adapt the amount of fuel gas which is injected in the gas engine per injection process. In one example, said first control unit 200 is arranged to adapt the point in time of igniting the fuel gas in the gas engine. The adaption is in one example the same adaption as is performed after a refuelling process. Adaption processes after refuelling are known in the art. Especially, said adaption can conclude performing measurements at the exhaust gas from the gas engine 270. Thus, a lambda sensor (not shown) can be arranged downstream the gas engine 270 for performing measurements at the exhaust gas. The adaption can comprise a feed-back system.

A second control unit 205 is arranged for communication with the first control unit 200 via a link L205 and may be detachably connected to it. It may be a control unit external to the vehicle 100. It may be adapted to conducting the innovative method steps according to the invention. The second control unit 205 may be arranged to perform the inventive method steps according to the invention. It may be used to cross-load software to the first control unit 200, particularly software for conducting the innovative method. It may alternatively be arranged for communication with the first control unit 200 via an internal network on board the vehicle. It may be adapted to performing substantially the same functions as the first control unit 200, such as adapting the control of the gas engine in a vehicle. The innovative method may be conducted by the first control unit 200 or the second control unit 205, or by both of them.

The engine system 299 can perform any of the method steps described later in relation to FIG. 4.

FIG. 3 shows, in a schematic way, an example of a pressure value p over time t as it could occur when performing the present disclosure. The pressure value can relate to a measured or a determined pressure value of the gas in the gas storage device 210. In the shown example the gas engine is started at time t=0. Usually, when starting the gas engine, the gas is taken from the gaseous phase out of the gas storage device. This is due to the fact that the gas pressure increases inside the gas storage device during non-operation of the gas engine. This is due to vaporisation of the gas inside the gas storage device. Thus, the gas is usually taken out in the gaseous phase first to lower the pressure inside the gas storage device. A first pressure value pₒ is achieved inside the gas storage device at time t=0. The pressure then drops basically linear until a second time t_{c}. At the second time a threshold value pₜ of the pressure will be achieved. This threshold value is in one example 10 bar. The threshold value is preferably higher than the desired input pressure of the gas engine 270. At the threshold value the gas will then be taken in its liquid phase out of the gas storage device. Since the gas in its liquid phase is several hundred times denser than in its gaseous phase, the pressure value will be basically constant, or at least drop significantly less than when taking out gas in the gaseous phase. As a consequence, when analysing a time derivative of the pressure in the gas storage device it will be possible to conclude whether the gas is taken out from the gaseous or from the liquid phase of the gas storage device. Basing a determination of from which phase the gas is taken on the time derivative of the pressure allows a determining of the phase even if a threshold of the valve arrangement is not known. If knowing the threshold for the valve arrangement it allows for determining whether the valve arrangement works properly.

It should be noted, that the concept of the present disclosure is also applicable in case the gas in its liquid phase is not several hundred times denser than in its gaseous phase. The gradient of the curve, i.e. the time derivative of the pressure, might be different in this case and/or the pressure value will not be basically constant in the liquid phase. However, there will still be a difference in the gradient between the liquid phase and the gaseous phase. This is all which is needed in this example to determine from which phase the fuel gas is taken out of the gas storage device.

FIG. 4 shows, in a schematic way, a flow chart over a method 300 for controlling a gas engine, wherein the gas engine is supplied with a fuel gas which consists of different kinds of molecules and which is stored in at least a gaseous phase and a liquid phase in a gas storage device. The method starts with the optional step 310.

In the optional step 310 a pressure value of the fuel gas in the gas storage device is determined. This is in one example performed by a measurement unit and/or a control unit. The pressure value is in one example determined in the gaseous phase of the fuel gas. In one example the pressure value is determined inside the gas storage device. In one example the pressure value is measured at a passage outside the gas storage device. Said passage is preferably connected to the gas storage device in such a way that the pressure in the passage corresponds to the pressure in the gas storage device or in such a way that it is possible to derive the pressure value in the gas storage device from the measurement outside the gas storage device. This can for example be achieved with the help of a model of the gas transport. Step 310 can be repeated continuously or intermittently. The determined pressure value(s) can be stored. The method continues with the optional step 320.

In the optional step 320 a time derivative of pressure values of the fuel gas in the gas storage device is determined. Said determination can be based on the stored values from step 310. Step 320 can be repeated (not shown in the Figure). In one example only step 320 is repeated. In one example, step 320 is repeated in combination with step 330. The method continues with step 330.

In step 330 it is determined from which of its liquid or gaseous phase the fuel gas is taken out of the gas storage device. In one example, this determination is based on said determined pressure value of the fuel gas in the gas storage device from step 310. As an example, a threshold pressure value for a valve could be known. From the determined pressure value it is thus possible to conclude the state of the valve. From the state of the valve it is possible to determine from which phase the gas is taken out of the gas storage device. This has been explained in connection to FIG. 2.

In one example, the determination is based on the determined time derivative of the pressure values of the fuel gas in the gas storage device from step 320. As an example, if the time derivative of the pressure value is above a threshold it can be concluded that the gas is taken out in a first phase and if the time derivative of the pressure value is below a threshold it can be concluded that the gas is taken out in a second phase. This has been explained in more detail in relation to FIG. 3.

In one example a control unit controls a valve which determines from which phase the gas is taken out of the gas storage device. In that case the control unit will immediately know from which phase the gas is taken out of the storage device. In one example, the control unit is able to receive information from a valve regarding the state of the valve. By receiving this information the control unit will be enabled to determine from which state the gas is taken out. The fact that the valve does not need to be controlled by a control unit allows the method to be implemented in existing vehicles without making any hardware adaptions of the valve.

Above, the method 300 has been described in relation to one valve. It should, however, be understood that the method easily is adapted to a valve arrangement as described in relation to FIG. 2.

In one example said determination is based on a model of the fuel gas and/or the gas storage device. Said model can comprise a set of parameters of the fuel gas and/or the gas storage device. Said set of parameters can comprise any of a composition of the fuel gas, a temperature of the fuel gas and/or the gas storage device, material parameters of the gas storage device, heat transfer parameters from the environment to the gas storage device, a pressure of fuel gas in the gas storage device, or the like. Said model can relate to the time behavior of said set of parameters. In one example said model receives an initial set of parameter values. Said initial set of parameter values can be provided or updated in relation to a refuelling. It is then possible to model the behavior in the gas storage device without the need to perform any measurements. From the model a pressure value of the gas in the gas storage device can be derived. From said pressure value it can then be determined from which of its liquid or gaseous phase the fuel gas is taken out of the gas storage device. This is analogous to what has been described in relation to a measured pressure value.

Step 330 can be repeated. The repetition can be only of step 330, or include one or both of step 310 and step 320. The method continues with step 340.

In step 340 the control of the gas engine is adapted in case it is determined that the phase from which the fuel gas is taken out of the gas storage device has changed. This can be achieved by performing step 330 at least a first time and a second time and determining whether the determined phase from step 330 has changed.

Said adaption can comprise any control parameter of the gas engine. In one example said adaption comprises a step 350 adapting the amount of fuel gas which is injected in the gas engine per injection process. In one example, the injection process relates to a direct injection process. In other words, the gas is directly injected into at least one combustion chamber of the gas engine without first being mixed to an air/fuel-mixture. In one example said adaption comprises a step 360 of adapting the point in time of igniting the fuel gas in the gas engine. This is commonly referred to as the angle of ignition. It relates for example to a certain angle of the piston and/or crankshaft position when ignition occurs.

Said adaption can be based on an analysis of exhaust of the gas engine. Said adaption can correspond to the same adaption which is usually performed when refuelling the vehicle and which is known in the art. After step 340 the method ends.

The method can be repeated continuously or intermittently.

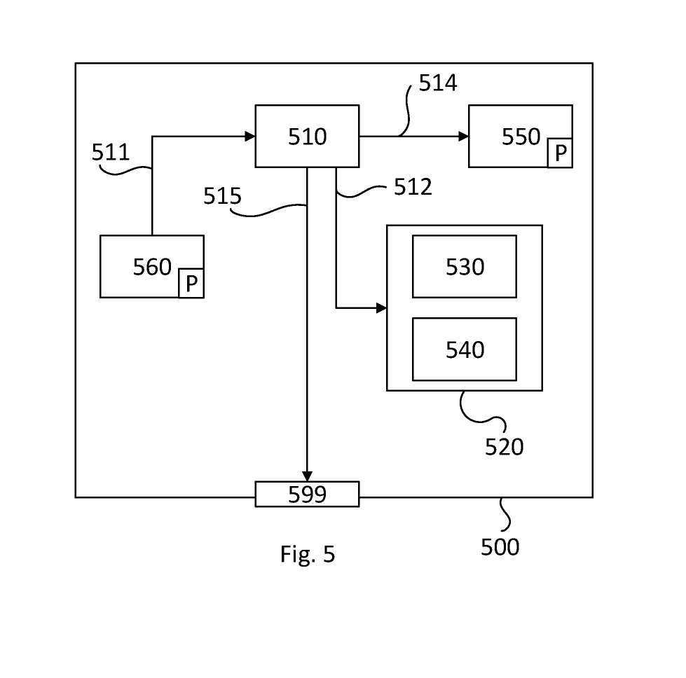

FIG. 5 is a diagram of one version of a device 500. The control units 200 and 205 described with reference to FIG. 2 may in one version comprise the device 500. The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

The computer program comprises routines for controlling a gas engine, wherein the gas engine is supplied with a fuel gas which consists of different kinds of molecules and which is stored in at least a gaseous phase and a liquid phase in a gas storage device.

The computer program P may comprise routines for adapting the control of the gas engine in case it is determined that the phase from which the fuel gas is taken out of the gas storage device has changed. This may at least partly be performed by means of said first control unit 200 controlling operation of the gas engine 270. The computer program P may comprise routines for adapting the amount of fuel gas which is injected in the gas engine per injection process. The computer program P may comprise routines for adapting the point in time of igniting the fuel gas in the gas engine.

The computer program P may comprise routines for determining a pressure value of the fuel gas in the gas storage device. This may at least partly be performed by means of said first control unit 200 and/or said measurement means 220. Said pressure value can be stored in said non-volatile memory 520.

The computer program P may comprise routines for determining a time derivative of pressure values of the fuel gas in the gas storage device. This may at least partly be performed by means of said first control unit 200, for example based on accessing stored pressure values from said non-volatile memory 520.

The computer program P may comprise routines for determining from which of its liquid or gaseous phase the fuel gas is taken out of the gas storage device. This may at least partly be performed by means of said first control unit. This might be based on whether said determined pressure value is above or below a pre-determined threshold. This might be based on whether said determined time derivative of pressure values is above or below a pre-determined threshold.

The computer program P may comprise routines for determining a state of a valve arrangement at an output of the gas storage device. This may at least partly be performed by means of said first control unit 200 controlling operation of the valve arrangement 240. This may be performed based on said pressure value and/or said time derivative of the pressure values.

The computer program P may comprise a model of the fuel gas and/or the gas storage device.

The program P may be stored in an executable form or in compressed form in a memory 560 and/or in a read/write memory 550.

Where it is stated that the data processing unit 510 performs a certain function, it means that it conducts a certain part of the program which is stored in the memory 560 or a certain part of the program which is stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit via a data bus 511. The read/write memory 550 is arranged to communicate with the data processing unit 510 via a data bus 514. The links L205, L220, L240, L250, and L270, for example, may be connected to the data port 599 (see FIG. 2).

When data are received on the data port 599, they can be stored temporarily in the second memory element 540. When input data received have been temporarily stored, the data processing unit 510 can be prepared to conduct code execution as described above.

Parts of the methods herein described may be conducted by the device 500 by means of the data processing unit 510 which runs the program stored in the memory 560 or the read/write memory 550. When the device 500 runs the program, methods herein described are executed.

The foregoing description of the preferred embodiments of the present invention is provided for illustrative and descriptive purposes. It is neither intended to be exhaustive, nor to limit the invention to the variants described. Many modifications and variations will obviously suggest themselves to one skilled in the art. The embodiments have been chosen and described in order to best explain the principles of the invention and their practical applications and thereby make it possible for one skilled in the art to understand the invention for different embodiments and with the various modifications appropriate to the intended use.

It should especially be noted that the system according to the present disclosure can be arranged to perform any of the steps or actions described in relation to the method 300. It should also be understood that the method according to the present disclosure can further comprise any of the actions attributed to an element of the engine system 299 described in relation to FIG. 2. The same applies to the computer program and the computer program product.

1. A method for controlling a gas engine, wherein the gas engine is supplied with a fuel gas which consists of different kinds of molecules and which is stored in at least a gaseous phase and a liquid phase in a gas storage device, the method comprising the steps of:
determining from which of its liquid or gaseous phase the fuel gas is taken out of the gas storage device; and
adapting the control of the gas engine in case it is determined that the phase from which the fuel gas is taken out of the gas storage device has changed.

2. The method according to claim 1, further comprising the step of determining a pressure value of the fuel gas in the gas storage device, and wherein said determination from which of its liquid or gaseous phase the fuel gas is taken out of the gas storage device is based on said determined pressure value of the fuel gas in the gas storage device.

3. The method according to claim 1, further comprising the step of determining a time derivative of pressure values of the fuel gas in the gas storage device, and wherein said determination from which of its liquid or gaseous phase the fuel gas is taken out of the gas storage device is based on said determined time derivative of the pressure values of the fuel gas in the gas storage device.

4. The method according to claim 1, wherein said determining from which of its liquid or gaseous phase the fuel gas is taken out of the gas storage device is based on a model of the fuel gas and/or the gas storage device.

5. The method according to claim 1, wherein said determining from which of its liquid or gaseous phase the fuel gas is taken out of the gas storage device is based on a determined state of a valve arrangement at an output of the gas storage device.

6. The method according to claim 1, wherein the step of adapting the control of the gas engine comprises adapting the amount of fuel gas which is injected in the gas engine per injection process.

7. The method according to claim 1, wherein the step of adapting the control of the gas engine comprises adapting the point in time of igniting the fuel gas in the gas engine.

8. The method according to claim 1, wherein the fuel gas which is stored in at least a gaseous phase and a liquid phase in the gas storage device is liquefied natural gas.

9. A system for controlling a gas engine, wherein the gas engine is supplied with a fuel gas which consists of different molecules and which is stored in at least a gaseous phase and a liquid phase in a gas storage device, the system comprising:
means for determining from which of its liquid or gaseous phase the fuel gas is taken out of the gas storage device; and
means for adapting the control of the gas engine in case it is determined that the phase from which the fuel gas is taken out of the gas storage device has changed.

10. The system according to claim 9, further comprising means for determining a pressure value of the fuel gas in the gas storage device and wherein said means for determining from which of its liquid or gaseous phase the fuel gas is taken out of the gas storage device is adapted to base said determining on said determined pressure value of the fuel gas in the gas storage device.

11. The system according to claim 9, further comprising means for determining a time derivative of pressure values of the fuel gas in the gas storage device, and wherein said means for determination from which of its liquid or gaseous phase the fuel gas is taken out of the gas storage device is adapted to base said determining on said determined time derivative of the pressure values of the fuel gas in the gas storage device.

12. The system according to claim 9, wherein said means for determining from which of its liquid or gaseous phase the fuel gas is taken out of the gas storage device are adapted to base said determining on a model of the fuel gas and/or the gas storage device.

13. The system according to claim 9, wherein said means for determining from which of its liquid or gaseous phase the fuel gas is taken out of the gas storage device are adapted to base said determining on a determined state of a valve arrangement at an output of the gas storage device.

14. The system according to claim 9, wherein the means for adapting the control of the gas engine comprises means for adapting the amount of fuel gas which is injected in the gas engine per injection process.

15. The system according to claim 9, wherein the means for adapting the control of the gas engine comprises means for adapting the point in time of igniting the fuel gas in the gas engine.

16. The system according to claim 9, wherein the fuel gas which is stored in at least a gaseous phase and a liquid phase in the gas storage device is liquefied natural gas.

17. A vehicle comprising a system for controlling a gas engine, wherein the gas engine is supplied with a fuel gas which consists of different molecules and which is stored in at least a gaseous phase and a liquid phase in a gas storage device, the system comprising:
means for determining from which of its liquid or gaseous phase the fuel gas is taken out of the gas storage device; and
means for adapting the control of the gas engine in case it is determined that the phase from which the fuel gas is taken out of the gas storage device has changed.

18. (canceled)

19. A computer program product stored on a non-transitory computer-readable medium, said computer program product for controlling a gas engine, wherein the gas engine is supplied with a fuel gas which consists of different kinds of molecules and which is stored in at least a gaseous phase and a liquid phase in a gas storage device, said computer program product comprising computer instructions to cause one or more electronic control units or computers to perform the following operations:
determining from which of its liquid or gaseous phase the fuel gas is taken out of the gas storage device; and
adapting the control of the gas engine in case it is determined that the phase from which the fuel gas is taken out of the gas storage device has changed.
